(19) United States
(12) Patent Application Publication
(10) Pub. No.: US 2008/0176620 A1
(43) Pub. Date: Jul. 24, 2008

(54) Gaming method and apparatus for dynamically identifying a segment of corresponding adjacent elements spanning at least two nodes

(76) Inventors: Bradley Berman, Minnetonka, MN (US); Ryan Strand, Hopkins, MN (US); Chad Shapiro, Plymouth, MN (US); Adam Martin, St. Louis Park, MN (US)

Correspondence Address: Hollingsworth & Funk, LLC, Suite 125, 8009 34th Avenue South, Minneapolis, MN, 55425, US

(21) Appl. No.: 12/004,454

(22) Filed: Dec. 20, 2007

Related U.S. Application Data
(60) Provisional application No. 60/877,754, filed on Dec. 29, 2006.

(51) Int. Cl. A63F 9/24; G06F 17/30

(52) U.S. Cl. 463/16; 463/20; 707/201

(57) ABSTRACT

A method and apparatus for use in gaming activities such as slot machine. A play area comprising a plurality of elements and at least two nodes are presented. At least some of the elements are marked. At least one winning segment of adjacently located elements with corresponding marks is dynamically identified, the winning segment spanning the at least two nodes. Other embodiments include marking the at least two nodes and identifying at least one winning segment of adjacently located elements with corresponding marks, the winning segment spanning the at least two nodes and the markings of the elements of the winning segment corresponding to the markings of the at least two nodes. Other embodiments include activating at least two nodes and dynamically identifying the winning segment of adjacently located elements with corresponding marks spanning the at least two activated nodes.

### RELATED APPLICATIONS

This application claims the benefit of Provisional Application No. 60/877,754, filed on Dec. 29, 2006, to which priority is claimed pursuant to 35 U.S.C. §119(e), and which is hereby incorporated herein by reference in its entirety.

### FIELD OF THE INVENTION

This invention relates in general to gaming systems and processes, and more particularly to a gaming method and apparatus for dynamically identifying a segment of corresponding adjacent elements spanning at least two nodes.

### BACKGROUND OF THE INVENTION

Gaming devices such as slot machines have entertained the public for over a century. While the fundamental concept behind slot games has remained relatively intact, the manners of computing, displaying, and participating in modern day slot games have changed dramatically. One force driving these changes is technological advancement, such as the advent of computers and video capabilities. Another driving force is human nature, as the participants of such gaming devices demand continual excitement and stimulation. It is therefore important in the gaming industry that gaming innovations continue to be rolled out to the participating public.

Conventional slot games and the like involve relatively linear game play that can become repetitive and monotonous for a player. For example, a conventional slot machine involves repeatedly spinning three reels in an attempt to line reel symbols up in a configuration that triggers a payout. While the outcome of each game is not predictable, the manner of game play is identical each time the game is played. Such games can have limited ability in sustaining a player's interest as the game play becomes monotonous over time.

### SUMMARY OF THE INVENTION

To overcome limitations in the prior art described above, and to overcome other limitations that will become apparent upon reading and understanding the present specification, the present invention discloses an apparatus and method for providing a game with a winning segment of corresponding adjacent elements spanning between two nodes.

In accordance with one embodiment of the invention, a method for facilitating participation in a game is provided. A play area comprising a plurality of elements and at least two nodes are presented. At least some of the elements are marked. At least one winning segment of adjacently located elements with corresponding marks is dynamically identified, the winning segment spanning the at least two nodes. Various embodiments may include marking the at least two nodes and identifying at least one winning segment of adjacently located elements with corresponding marks, the winning segment spanning the at least two nodes and the markings of the elements of the winning segment corresponding to the markings of the at least two nodes. Various embodiments may include activating at least two nodes and dynamically identifying the winning segment of adjacently located elements with corresponding marks spanning the at least two activated nodes.

In accordance with another embodiment of the invention, a method for facilitating participation in a game is provided. A display grid and at least three nodes are presented. The display grid is populated with a plurality of marking elements, the marking for each element selected from a plurality of different markings. At least two of the at least three nodes are activated. At least one winning segment is identified, wherein the winning segment forms a contiguous segment of marking elements between at least two activated nodes, and all of the elements comprising the winning segment have corresponding markings. Other embodiments include randomly selecting the at least two nodes to be activated.

In accordance with another embodiment of the invention, a method for facilitating participation in a game is presented. A play area that includes at least two nodes is presented. The at least two nodes are marked, the markings selected from a plurality of different markings. The play area is populated with a plurality of marking elements, the marking for each element selected from the plurality of different markings. At least one winning segment is identified, wherein the winning segment forms a contiguous segment of marking elements between, and in contact with, the at least two nodes, and all of the elements comprising the winning segment, and the at least two nodes, have corresponding markings. Other embodiments include randomly selecting, from at least three nodes, the at least two nodes between which the winning segment forms a contiguous segment of correspondingly marked elements.

In accordance with another embodiment, a gaming apparatus hosting a gaming activity is provided. The gaming apparatus includes a display device to present a display grid having a plurality of elements and at least two nodes. The gaming apparatus also includes a random number generator configured to facilitate random selection of a marking for presentation for each of a plurality of elements of the display grid. The gaming apparatus also includes a processor configured to facilitate identification of at least one winning segment of adjacently located elements with corresponding marks, the winning segment spanning the two nodes. Various embodiments may include that the random number generator is configured to facilitate selection of the marking for each of the plurality of elements from a plurality of possible different markings that can each be repeatedly selected for marking by the random number generator.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

The invention is described in connection with the embodiments illustrated in the following diagrams.

FIG. 1 illustrates one embodiment of a gaming activity utilizing a segment of adjacent corresponding elements spanning two nodes in accordance with the invention;

FIG. 2 is a flow diagram of an exemplary embodiment of a method for utilizing segments of adjacent corresponding elements in accordance with the invention;

FIG. 3 shows two flow diagrams of other exemplary embodiments of methods for utilizing segments of adjacent corresponding elements spanning two nodes in accordance with the invention;

FIG. 4 illustrates another embodiment of a gaming activity utilizing segments of adjacent corresponding elements spanning two nodes in accordance with the invention;

FIGS. 5-7 provide examples of particular embodiments of a gaming activity utilizing segments of adjacent corresponding elements spanning two nodes in accordance with the invention;

FIG. 8 is an embodiment of a casino-style gaming device in which the principles of the present invention may be applied; and

FIG. 9 illustrates a representative computing system capable of carrying out operations in accordance with the invention.

### DETAILED DESCRIPTION OF THE ILLUSTRATED EMBODIMENTS

In the following description of the invention, reference is made to the accompanying drawings which form a part-hereof, and in which is shown by way of illustration the specific embodiment in which the invention may be practiced. It is to be understood that other embodiments may be utilized, as structural and operational changes may be made without departing from the scope of the present invention.

Generally, the present invention is directed to a method and apparatus for providing segments of adjacent corresponding elements spanning at least two nodes. As discussed herein, there are multiple manners of forming the segment. In contrast to the lining up of three symbols in a conventional slot game, the present invention provides an almost unlimited variety of ways for forming segments of corresponding symbols and/or colors. Such unpredictable manner of game play can sustain a player's interest over a longer period of time as compared to conventional slot games with more limited game play.

Additionally, the present invention provides several opportunities during the course of game play to further randomize the result or provide player control. For example, the nodes themselves may be marked, such that the markings of the adjacent elements of the winning segment must not only correspond to one another, but must also correspond to the markings of the nodes. Also, three or more nodes can be provided, where only two of the three or more nodes are activated to allow a segment of adjacent corresponding elements spanning between them to be a winning segment that triggers a payout. Nodes may be randomly activated or selected by a player. Such aspects of the present invention further enhance game play by adding important and suspenseful events to the course of a game. These and other advantages are provided by the invention described herein, as will be apparent to one having ordinary skill in the art upon reading the present disclosure.

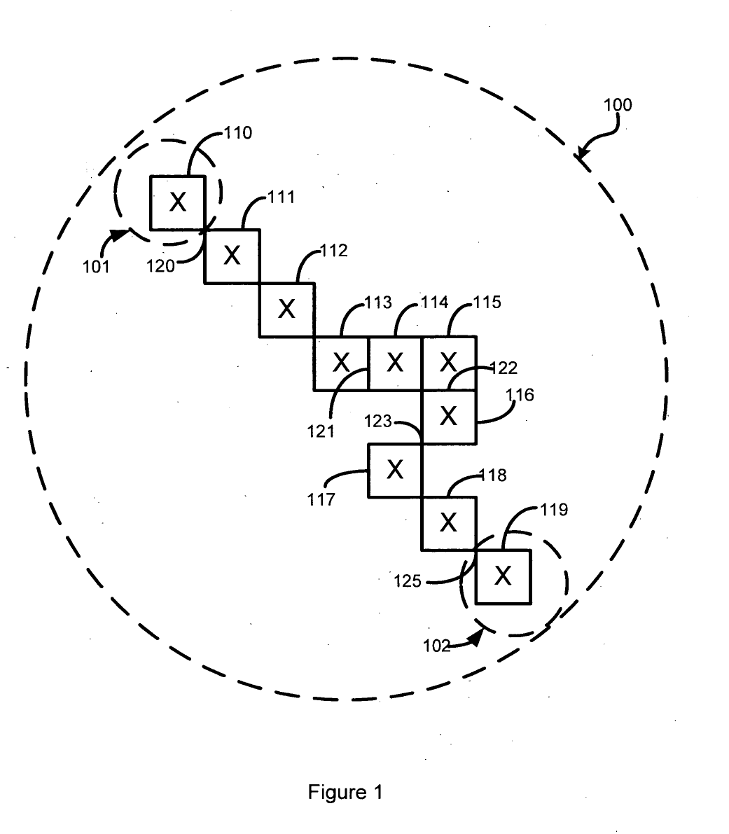

FIG. 1 illustrates a segment of adjacent element spanning two nodes. Within play area 100 are elements 110-119. Elements 110-119 are illustrated as squares, but in various other embodiments of the invention, elements 110-119 could be other shapes, including but not limited to circles, ovals, triangles, pentagons, hexagons, octagons, and the like. Each element 110-119 is illustrated as including four sides and four corners.

Nodes 101 and 102 are also located within the play area 100. Although nodes 101 and 102 are illustrated as particular area boundaries within the play area 100, nodes of the various embodiments of the invention can also be elements themselves. A node could also be a single point, line, boundary or periphery area on, around, or in the play area 100.

Elements 110-119 are all located adjacent to one another. There are many different ways in which elements of the various embodiments of the invention can be adjacent to one another. For example, element 110 shares corner 120 with element 111. Also, element 113 is adjacent to element 114 because both elements share common vertical wall 121. Element 115 is adjacent to element 116 because both elements share common horizontal wall 122. One element can be adjacent to multiple other elements. For example, element 116 is adjacent to element 115 because they both share a common horizontal wall 122. Furthermore, element 116 is adjacent to element 117 because both they both share corner 123.

According to various embodiments of the invention, elements in contact with and/or within close proximity to one another can be considered to be adjacent. Elements can be in contact with one another by sharing walls, lines, points, segments, portions and/or features. Elements can also be in contact by overlapping each other. Other types of adjacency may be provided as well. For example, in one embodiment, only those symbols that are adjacent in a horizontal or vertical fashion will be deemed “adjacent” for purposes of providing a payout. Alternatively, only symbols that are horizontal, or that are vertical, or that are diagonal, may be deemed adjacent. Symbols may also be deemed adjacent along opposite edges of the play area, as if the edges were wrapped around to intersect with one another. 3 dimensional display grids may also be used in accordance with the invention, such that elements sharing a wall, corner or segment may be considered to be adjacent.

Although the elements of the embodiment of FIG. 1 are adjacent to another if they share a corner or wall, in various embodiments of the invention, elements are only considered to be adjacent if they share a wall or their walls are parallel and oppose one another, where mere corner contact and/or proximity is not sufficient. In some alternative embodiments, mere wall contact between elements or wall proximity is not sufficient, and two elements will only be classified as adjacent if they have respective corners contacting or opposing one another.

Element 110 is located in node 101 and element 119 is located in node 102, and as such, the segment formed by elements 110-119 spans the nodes 110 and 119. According to various embodiments of the invention, there are several ways in which a segment of elements can span a node. For example, a segment of elements can form a contiguous series of elements in which the segment crosses, intersects, overlaps, contacts, abuts or is in someway associated with a node by proximity. Furthermore, the segment of elements can do so between two nodes, such that the segment of elements spans between the nodes. For example, elements 111-118 also form a segment spanning nodes 101 and 102, because corner 120 of element 101 contacts the boundary of node 101 and corner 125 of element 118 contacts the boundary of node 119. This disclosure also contemplates embodiments of the invention where multiple segments of elements span two nodes and/or a segment of elements spans three or more nodes.

Elements 110-119 all contain an “X” marking. In the embodiment illustrated in FIG. 1, the elements 110-119 correspond to one another because of the “X” marking.

While elements 110-119 of the embodiment of FIG. 1 correspond to one another because each has been marked with an “X” marking, there are various other ways in which elements can correspond to one another, according to various embodiments of the invention. For example, elements could correspond to one another not by having the same mark, but rather by just having a mark at all. But in some embodiments of the invention, elements will only correspond if they have the same letter, number, symbol, image, color, or other similar marking. In some embodiments of the invention, elements will correspond if they are marked with markings selected from a particular group, and the elements need not all have identical markings to correspond to one another. For example, elements of a segment may correspond because each is marked with an image of a dog, even though all image markings on the elements are of a different breed of dog.

In some embodiments of the invention, elements correspond to one another if their markings form a progressive series. In such embodiments, adjacent elements might only correspond if they are marked with consecutive numbering, such as if elements 110, 111, 112, 113, 114, 115, 116, 117, 118, and 119 were each marked 1, 2, 3, 4, 5, 6, 7, 8, and 9, respectively. In other embodiments, letter marked elements of a segment may only correspond if the adjacent elements spell a word. However, the present invention is not so limited. Other types of element correspondence are contemplated and should be realized by one or ordinary skill in the art upon reading this disclosure.

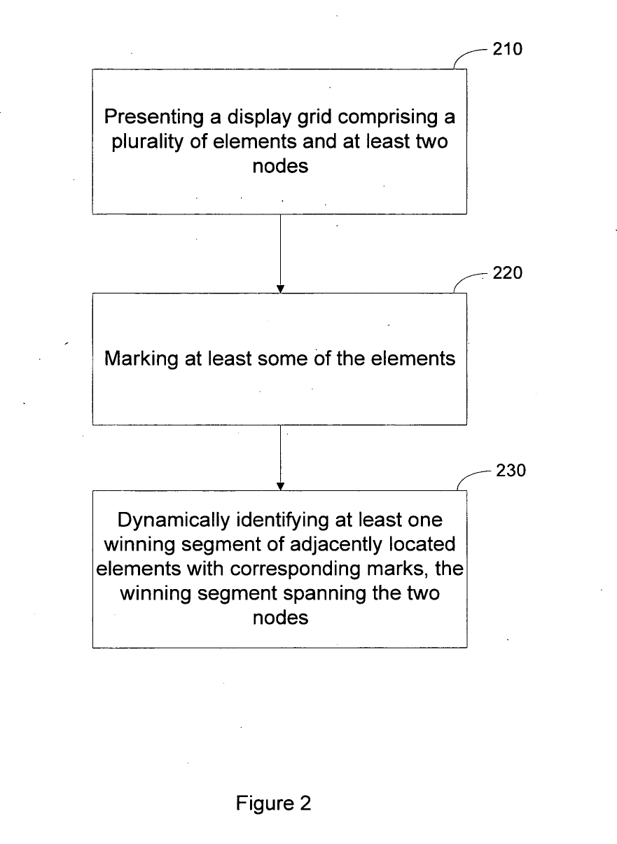

FIG. 2 is a flow diagram of an exemplary embodiment of a method for utilizing a segment of corresponding adjacent elements spanning two nodes in accordance with the invention. A display grid is presented 210, the display grid comprising a plurality of elements and at least two nodes. Various types of display grids are contemplated in the scope of the invention, including vertical and horizontal lines creating spaces of rectangles and/or squares. A display grid could also be comprised of triangles, hexagons, ovals, circles and other shapes.

A display grid can be presented in various ways. For example, a display grid could be comprised of several reel strips with various markings on the periphery of the reel strips. Several reel strips with a common axis placed together can form a grid, with each reel strip representing a vertical column and adjacent markings on the aligned reels representing a horizontal row. A display grid could also be printed on a surface, such as a piece of paper or board. A grid could also be represented by projected light.

A display grid can also be presented by use of video means, such as with a video slot machine. In a video slot machine, the reel strips are not represented by physical material, but rather include electronically stored symbol patterns, i.e., a virtual reel strip. By using virtual reel strips for each of the display subsegments, there is no physical correlation between display subsegments as there are with mechanical reel strips. For example, in the context of mechanical reel strips, three symbols presented in a column across three paylines are physically restricted to that particular order, since the reel strip is presented across three rows. In an exemplary embodiment of the invention, there is no such relationship and each subpart of the grid can display a marking independent of any other subpart. Furthermore, there are other advantages by using video representation, including faster game play, greater flexibility in game types and variations, and representation of things that would otherwise be physically complicated or impossible.

The flow diagram of FIG. 2 further includes marking at least some of the elements 220. In some embodiments of the invention, all of the elements are marked.

Marking includes distinguishing at least one element from at least one other element. There are many ways in which one element can be distinguished from another element, and therefore there are many different ways to mark an element. For example, an element could be marked simply by it being created or located in the display grid. Marking can also include placing and/or representing a symbol, one or more colors, flag, character, image, graphic, number, letter, shape, feature, or design on an element.

One element can be distinguished from another element to mark the element by locating the elements at different heights, rotating one or both of the elements, flipping one or both of the elements, moving one or both of the elements, resizing one of both of the elements, deforming one or both of the elements, modifying one or both of the elements and/or combining one or both of the elements with at least one other element. Distinguishing of elements can be done to physical elements, such as element pieces of a board or on a reel strip. Distinguishing of elements can also be done to elements represented on a display screen.

Marking is not limited to elements. Various types of nodes of the present invention can also be similarly marked. Grid spaces can also be marked.

The flow diagram of FIG. 2 further includes dynamically identifying 230 at least one winning segment of adjacently located elements with corresponding marks, the winning segment spanning the two nodes. Dynamic identification includes locating winning segments that can take any number of forms. As opposed to classic 3 reel strip slot matching, where a series of winning symbols could only be formed along one row, dynamic identification allows segments to be formed in many other ways, including segments that repeatedly change direction along their length.

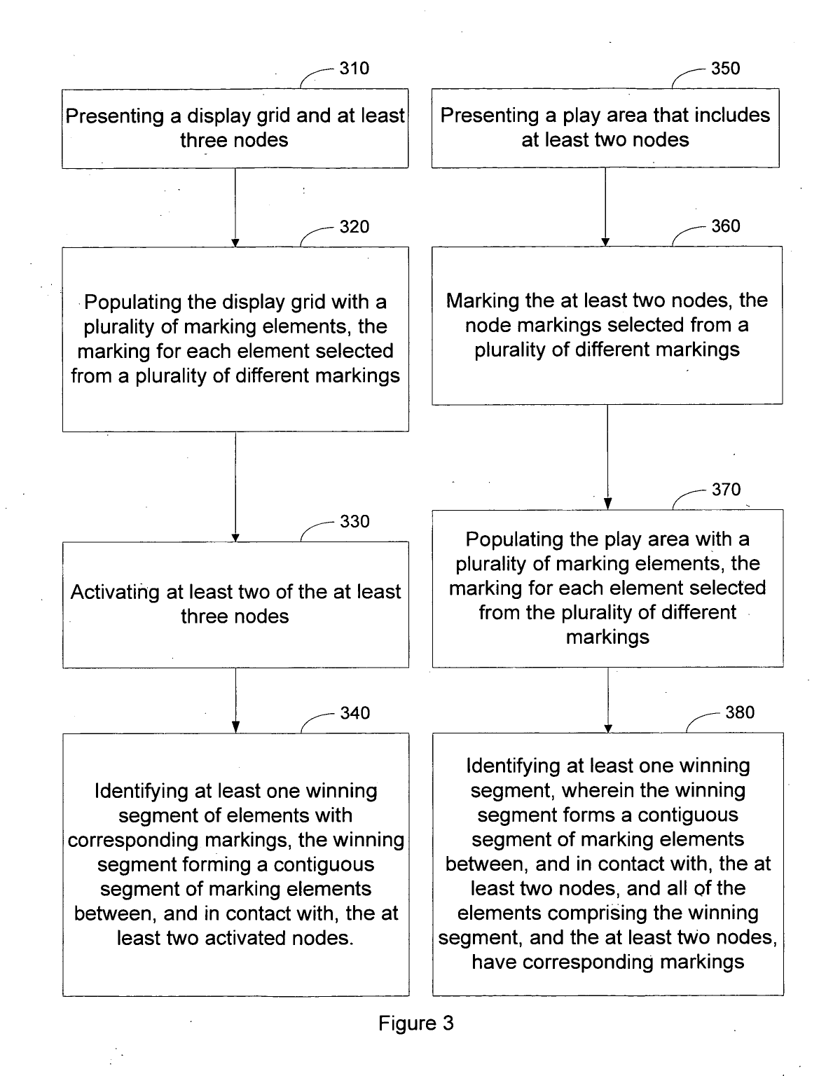

FIG. 3 shows two flow diagrams of exemplary embodiments of methods for utilizing a segment of corresponding adjacent elements spanning two nodes in accordance with the invention. According to one embodiment, a display grid and at least three nodes are presented 310. The nodes can be presented as part of the display grid, as elements of the display grid, as separate from the display grid, and/or as surrounding the peripheral edge of the display grid. The display grid is populated 320 with a plurality of marking elements, the marking for each element selected from a plurality of different markings. In various embodiments of the invention, a particular type of marking from the plurality of different markings can be repeatedly used to mark populating elements. In other embodiments, a particular type of marking from the plurality of different markings can only be used to mark populating elements a certain number of times.

The method further includes activating 330 at least two of the at least three nodes. Activating a node could include selection of the node by, among other means, a random number generator or a spinner stopping on the node. The activation of a node may be indicated to the user in some way. For example, if a display screen is used, then the node can be highlighted, colored, outlined and/or caused to blink. If a mechanical spinner is used to activate a node, then a pointer of the spinner could be used to indicate activation.

Nodes may be randomly activated, activated by a player, or they may be activated according to a pre-made plan. In some embodiments, nodes can be activated in groups, such that opposing nodes on the periphery of a play area are randomly selected from a group of node pairs, each pair of nodes opposing each other.

The method further includes identifying 340 at least one winning segment of elements with corresponding markings, the winning segment forming a contiguous segment of marking elements between, and in contact with, the at least two activated nodes.

Another method embodiment of FIG. 3 includes presenting a play area that includes at least two nodes. The method further includes marking the at least two nodes 360, the node markings selected from a plurality of different markings. The marking of nodes according to various embodiments of the invention can be done in anyway described herein for the marking of elements.

In some embodiments of the invention, having node markings that do not correspond to each other will preclude the forming of winning segments of corresponding adjacent elements spanning two nodes, wherein the rules in those particular embodiments require that the elements of the segment also correspond to the markings of the nodes between which the segment spans. In some embodiments, having node markings that do not correspond to each other will not preclude the formation of a winning segment spanning the nodes. For example, if a first node is marked with a “1” and a second node is marked with a “4”, these marking might not correspond to each other alone, but if elements marked “2” and “3” spanned the node, then a winning segment is not precluded.

The method further includes populating 370 the play area with a plurality of marking elements, the marking for each element selected from the plurality of different markings. The method further includes identifying 380 at least one winning segment of elements with corresponding markings, the winning segment forming a contiguous segment of marking elements between, and in contact with, the at least two activated nodes, wherein the markings of the at least two nodes correspond to the markings of the elements of the winning segment.

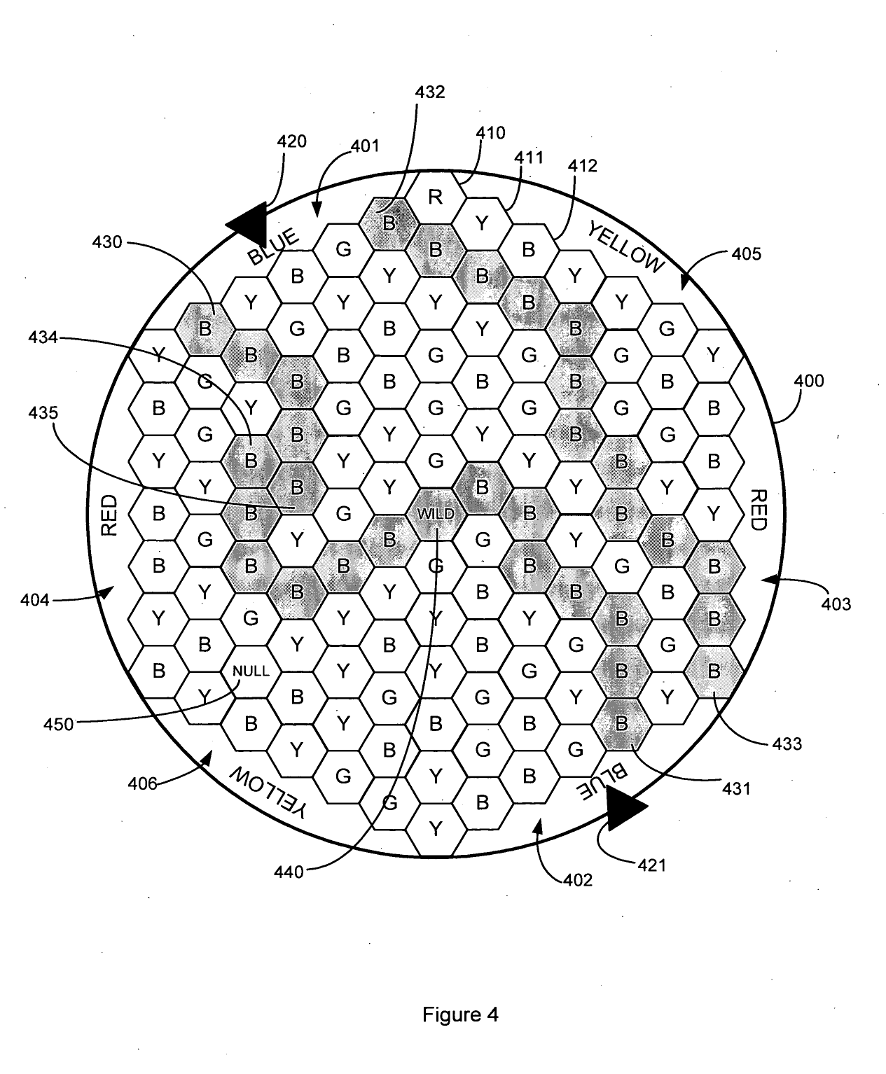

FIG. 4 provides an example of a particular embodiment of a gaming activity utilizing a segment of corresponding adjacent elements spanning two nodes. This embodiment includes a play area boundary 400, inside of which is a play area. In the embodiment illustrated in FIG. 4, the play area includes a display grid comprised of aligned hexagons, such as hexagons 410, 411 and 412. Also within the play area are nodes 401-406. Each node is associated with a color, as labeled. Therefore, nodes 401 and 402 are associated with the color blue, nodes 403 and 404 are associated with the color red, and nodes 405 and 406 are associated with the color yellow. In various embodiments of the invention, nodes 401-406 could be colored according to their respective associated color.

All elements within the play area boundary are marked with one of the following letters: an “R”, such as element 410, a “Y”, such as element 411, or a “B”, such as element 412. In various embodiments of the invention, each of these marking letters could represent a different color attribution, such as red for R, yellow for Y and blue for B. The elements of FIG. 4 are illustrated as being marked with letters corresponding to colors, but in other embodiments of the invention, the elements might be colored the associated color and not have any text associated with the element, or elements could include both the letter marking and coloring.

FIG. 4 also includes indicators 420 and 421. Indicators 420 and 421 are positioned opposed to one another along the play area boundary 400. Although indicators 420 and 421 are positioned opposed to one another, indicators of the various embodiments of the invention are not opposed to each other. Indicators 420 and 421 are positioned over nodes 401 and 402, respectively. The presence of an indicator over a node can signify that the node is selected and/or active.

Indicators 420 and 421 can be made to orbit the play area and/or move along the play area boundary 400, such that different nodes, such as nodes 401-402, can be selected and/or activated. Indicators 420 and 421 may mechanically spin around the play area boundary 400 or may be represented to do so on a video screen. Indicator motion is not limited to rotational motion, as various other ways of moving an indicator are contemplated within the invention. Moreover, use of an indicator, such as indicators 420 and 421, is not the only way to select and/or activate a node. A node could be selected and/or activated by outlining the node, highlighting the node, and/or representing the node as changing color, shape and/or configuration.

FIG. 4 illustrates that indicators 420 and 421 are over nodes 420 and 421, respectively, and therefore nodes 420 and 421 are activated. Between, and in contact with, activated nodes 420 and 421 are segments of adjacent corresponding elements. One such segment is the highlighted segment of elements between elements 432 and 433. The highlighted segment of elements between elements 432 and 433 is a winning segment because it is comprised of adjacently located corresponding elements spanning the two activated nodes 401 and 402. The elements of the highlighted segment between elements 432 and 433 correspond because each has been marked with a “B”. As discussed hereinbefore, the elements marked with a “B” might be colored blue, as nodes 401 and 402 can be as well. Therefore, a game player can see a contiguous line of blue elements between two blue nodes, indicating a win.

There are various reasons that the segment of highlighted elements between elements 432 and 433 could be a winning segment. For example, some embodiments of the invention may require that the elements of a winning segment correspond in some way to the nodes between which the elements form a contiguous segment. In the embodiment illustrated in FIG. 4, the correspondence could be that all elements of the highlighted segment between elements 432 and 433 are attributed with a B or blue color. Some embodiments may require that a winning segment span between two activated nodes. Some embodiments may require that the winning segment span between nodes that correspond to the elements of the winning segment, such as the elements and nodes being marked blue. Some embodiments may require that the winning segment span between activated and/or selected nodes that also correspond to the elements of the winning segment, such as the elements and nodes being marked with a common symbol.

The highlighted segment of elements between elements 432 and 433 spans between nodes 402 and 401. The highlighted segment of elements between elements 432 and 433 span nodes 401 and 402 because the elements form a contiguous chain of elements that contacts both nodes 401 and 402. It is elements 432 and 433 that are in contact with nodes 401 and 402, respectively. The highlighted segment of elements between elements 432 and 433 is between nodes 401 and 402, even though some of the elements deviate laterally from being entirely sandwiched between the nodes 401 and 402. Element 432 contacts node 401 because they both share at least one boundary. However, in some embodiments, the end elements of a winning segment might need to overlap or intersect with a node, not merely contact the node.

In some embodiments, multiple winning segments can overlap and/or share elements. For example, two overlapping winning segments are highlighted in FIG. 4. Both overlapping winning segments are between elements 430 and 431. One of the overlapping winning segments crosses element 434, while the other overlapping winning segment does not, and instead crosses element 435.

The winning segments between elements 430 and 431 both cross over wild element 440. Wild element 440 could be marked to include an R, Y and B, such that it could correspond to any element with an R, Y or B. As illustrated in FIG. 4, wild element 440 is not marked with an R, Y or B, but nevertheless, it can still correspond to the other elements of the winning segments and be a crucial element in the formation of the winning segment. The wild element 440 is placed in the middle of the play area, but various embodiments of the invention are not so limited. For example, one or more wild elements could be placed at planned, or random, places in the play area.

The play area of FIG. 4 also includes a null element 450. Null element 450 is not able to correspond to other elements because it lacks an R, Y, or B marking. Although only one null element is illustrated in FIG. 4, multiple null elements could be located in the play area. An element could become a null element because it was marked as such, or the null element could be located in the play area before other elements are located and/or marked. Null elements could be randomly located or could be located at planned positions.

As one or ordinary skill in the art will understand, the addition of null elements diminishes the chances of forming winning segments of corresponding adjacent elements spanning at least two nodes. The use of null elements can be used to control the odds of a player winning and/or enhance the thrill of game play.

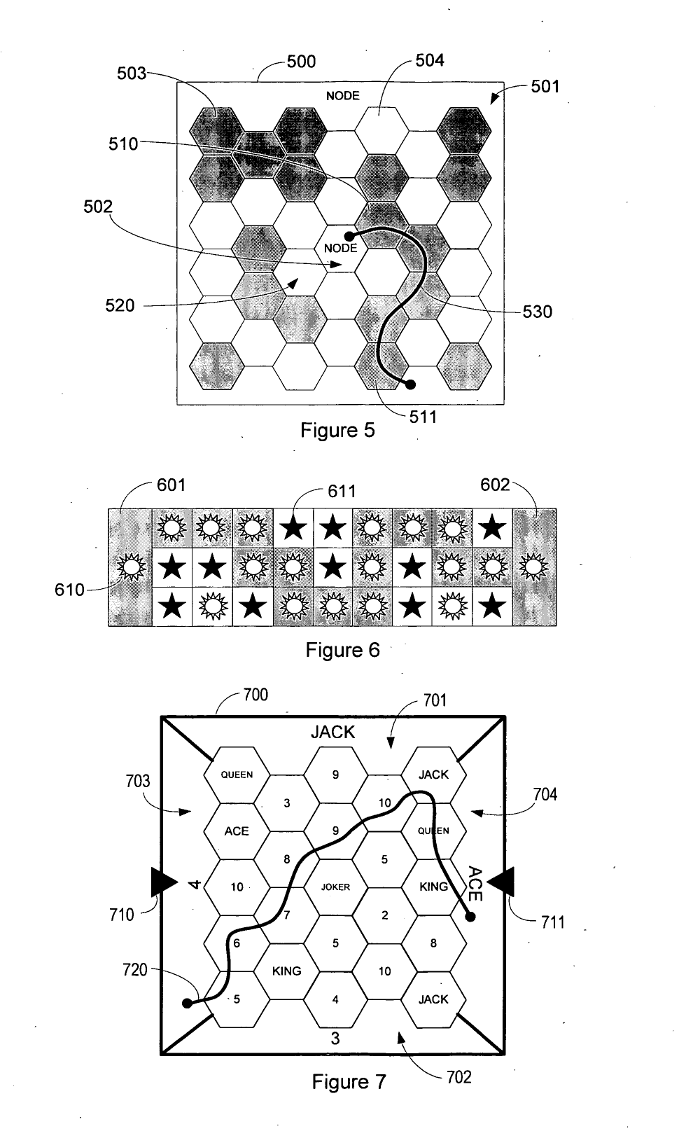

FIG. 5 provides an example of a particular embodiment of a gaming activity utilizing a segment of corresponding adjacent elements spanning two nodes. FIG. 5 illustrates, among other things, that nodes of the invention can take many different forms, and even different forms in a single embodiment. For example, the dimensional size of node 501 encompasses all elements of the play area 500, while node 502 is merely an element of the play area 500. The play area 500 has been populated with marked elements, such as marked element 503, which are distinguished from unmarked spaces, such as unmarked space 504, by being highlighted. The play area 500 can be randomly populated or can be populated according to a planned design or outcome.

FIG. 5 illustrates a winning segment of corresponding adjacent elements spanning two nodes. The segment is indicated by trace 530, which overlaps the winning segment and nodes 502 and 501. The elements of the winning segment correspond because they are all marked. Moreover, the two ends of the winning segment, elements 510 and 511, contact the two nodes 502 and 501, respectively.

FIG. 5 illustrates only two nodes, but more nodes can be located within play area 500 and/or node 502 can be placed at another location. For example, if node 502 had been placed at space 520, then no line segment of corresponding elements could span two nodes. In various embodiments of the invention, one or more nodes are randomly placed in a play area during the course of each game. One of ordinary skill in the art will understand that randomly locating nodes during game play enhances the thrill of the gaming experience by adding unpredictability. Also, the odds of winning can be controlled by the number of nodes placed.

FIG. 6 illustrates a winning segment of corresponding adjacent elements spanning two nodes. The play area of the embodiment of FIG. 6 is framed on each end by nodes 601 and 602. Elements of the play area and nodes 601 and 602 are marked with various symbols, such as star symbol 611 and sun symbol 610. While only two nodes are illustrated in FIG. 6, the embodiment illustrated in FIG. 6 requires that the elements of a winning segment correspond both to each other and to the nodes between which the segment spans. The winning segment, which includes nodes 601 and 602, is highlighted. Embodiments of the invention that require elements of a winning segment to correspond to the nodes between which the winning segment spans adds a dimension to game play that can control the odds of a player winning and/or enhance enjoyment of game play. For example, the play area might be populated by marked elements before the nodes are marked, adding suspense to the game.

FIG. 7 illustrates a winning segment of corresponding adjacent elements spanning two nodes. Play area 700 includes nodes 701, 702, 703, and 704, and hexagonal elements. The nodes 701, 702, 703 and 704 are located on the periphery of the playing area 700, surrounding the hexagonal elements. The hexagonal elements are each marked. Each marking is associated with a type of playing card. Indicators 710 and 711 are positioned on the periphery of the playing area 700, overlapping nodes 703 and 704, respectively. In the embodiment illustrated in FIG. 7, nodes 703 and 704 are activated because the indicators 710 and 711 overlap them, respectively. In various embodiments of the invention, indicators 710 and 711 could be located on adjacent sides, such that they activate nodes 701 and 704. In various embodiments of the invention, more than two indicators can be used, such that three or more nodes can be activated at a time. Indicators 710 and 711 can be randomly placed as a part of game play, or they can be placed at planned positions.

As one having ordinary skill in the art will understand, a straight is a series of sequentially corresponding cards of a deck, such as 2-3-4-5-6-7-8-9-10-JACK-QUEEN-KING-ACE. JOKER cards are sometimes included in card decks.

In the embodiment illustrated in FIG. 7, a winning segment of corresponding adjacent hexagonal elements spanning two nodes is indicated by trace 720. The hexagonal elements of the winning segment correspond because each is marked with a card type, and the sequence of hexagonal elements matches the sequence of a straight. In the embodiment illustrated in FIG. 7, hexagonal elements of a winning segment must also correspond to the markings of the nodes between which the winning segment spans. Therefore, the 4 of node 703 and the ACE of node 704 are included in the straight of 4 (node 703), 5, 6, 7, 8, 9, 10, JACK, QUEEN, KING, ACE (node 704). In some embodiments of the invention, a JOKER marking can be considered wild, such that the JOKER marking can substitute for any other necessary card type. In other embodiments, a JOKER marking functions as a null element, such that it cannot correspond to any other elements.

In the embodiment illustrated in FIG. 7, winning segments can only be created between activated and/or selected nodes. Nodes 703 and 704 are selected by indicators 710 and 711, respectively, while nodes 701 and 702 are not selected. Had nodes 701 and 701 been selected, then a winning segment would have been created if the JOKER was considered wild, and not null. In such a case, the markings of the winning segment would have comprised 3 (node 702), 4, 5, 6 (wild JOKER), 7, 8, 9, 10, and JACK (node 701).

The present invention is applicable to various gaming activities that are played on a gaming board or gaming machine, including slot games such as reel slots and video slots, and other games utilizing a string of symbols to generate a game result. The present invention is described in terms of slot machines to provide an understanding of the invention. While the invention is particularly advantageous in the context of slot machines, and while a description in terms of slot machines facilitates an understanding of the invention, the invention is also applicable to other gaming activities of chance utilizing symbol strings as will be readily apparent to those of skill in the art from the description provided herein.

The present invention provides segments of adjacent corresponding elements spanning at least two nodes. However, the invention is equally applicable in connection with secondary modes, such as bonus modes of play. As is known in the art, bonus events are used in gaming activities such as slot games, which provides an alternative mode of play that is intended to attract and captivate players of such slot games. Generally, a bonus game or event on a slot machine is typically an additional gaming reel or machine, or a random selection device, that is enabled by a bonus qualifying signal from an underlying or primary gaming activity. Generally, a predetermined prize-winning combination of symbols in an underlying or primary slot game may result in the player being awarded one or more bonus games. Often the bonus event has a much higher probability of winning, thereby instilling a great interest by players in being awarded bonus events. There are various secondary or “bonus” events known in the art. Thus, while an exemplary embodiment of the present invention is described in connection with a standard or primary mode of play, the present invention is equally applicable in secondary or bonus modes of play.

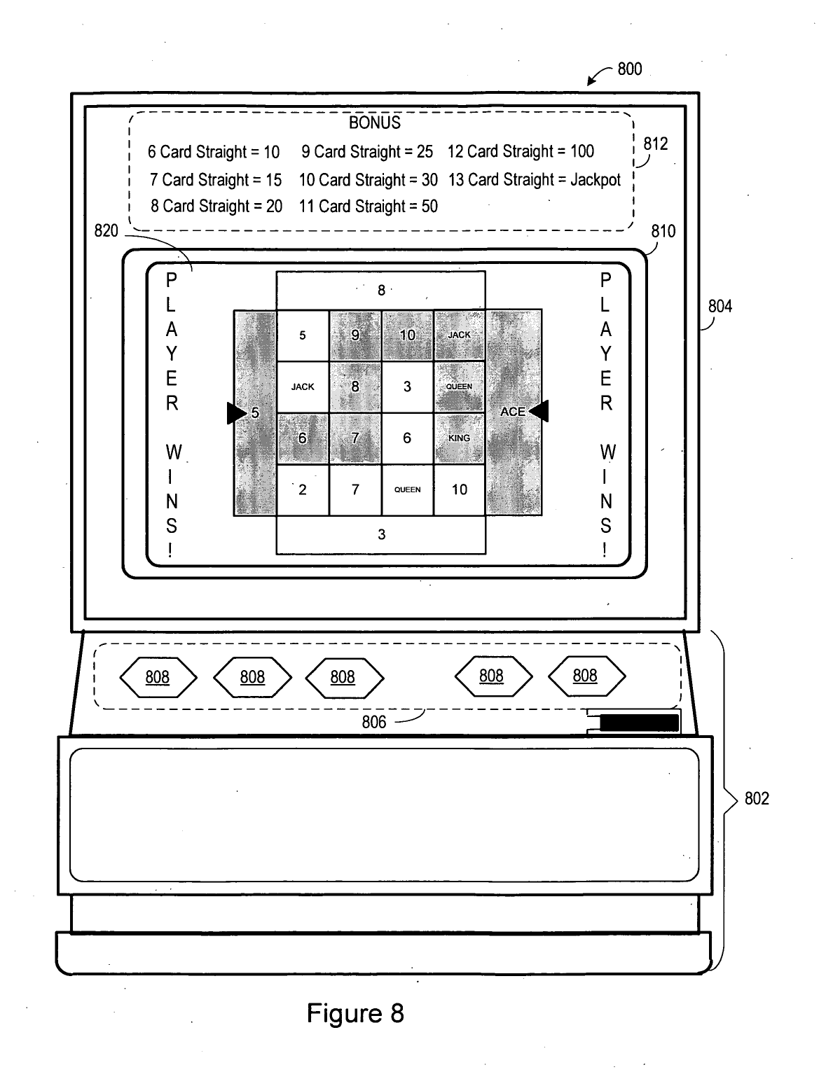

FIG. 8 is an embodiment of a casino-style gaming device in which the principles of the present invention may be applied. The slot machine 800 is a structure including at least a computing system, a housing, and a display. The housing includes a base 802 and a display device 804 to allow the slot machine 800 to be a self-supported, independent structure. The base 802 includes structure supporting the slot machine 800, and also includes a user interface 806 to allow the user to control and engage in play of the slot machine 800. The particular user interface mechanisms associated with user interface 806 is dependent on the type of gaming machine. For example, the user interface 806 may include one or more buttons, switches, joysticks, levers, pull-down handles, trackballs, voice-activated input, or any other user input system or mechanism that allows the user to participate in the particular gaming activity. The user input 806 allows the user to enter coins or otherwise obtain credits through vouchers, tokens, credit cards, etc. Various mechanisms for entering such vouchers, tokens, credit cards, coins, point tickets, etc. are known in the art. For example, coin/token input mechanisms, card readers, credit card readers, smart card readers, punch card readers, and other mechanisms may be used to enter wagers. The user input may include a plurality of buttons 808, which allow the user to initiate the game play in accordance with the invention, enter a number of credits to play, select options, cash out, automatically bet the maximum amount, etc. It should be recognized that a wide variety of other user interface options are available for use in connection with the present invention, including pressing a button on a gaming machine, touching a segment of a touch-screen, entering text, entering voice commands, or other user entry methodology.

Returning now to FIG. 8, the display device 804 includes a display screen 810. The display device may take on a variety of forms depending on what type of presentation is to be provided. For example, a slot game area 820 is provided where the slot gaming activity in accordance with the invention is displayed. The video display screen may be implemented in a variety of manners, including electronically represented with outputs shown on conventional electronic displays, such as a liquid crystal displays (LCD), dot matrix, plasma, CRT, LED, electro-luminescent display, or generally any type of video display known in the art.

Also associated with the display device 804 is an optional winning guide area 812, where information associated with the potential winning segment lengths may be presented. This area may also provide an indication of the requisite symbols, symbol lengths, symbol combinations, symbol locations, etc. that result in winning payouts to the participant. This information may be part of the display screen 810, or alternatively may be separate from the display screen 810 and provided directly on a portion of the display device 804 structure itself. For example, a backlit colored panel may be used as the winning guide area 812. Further, this information may be provided on an entirely separate display screen (not shown).

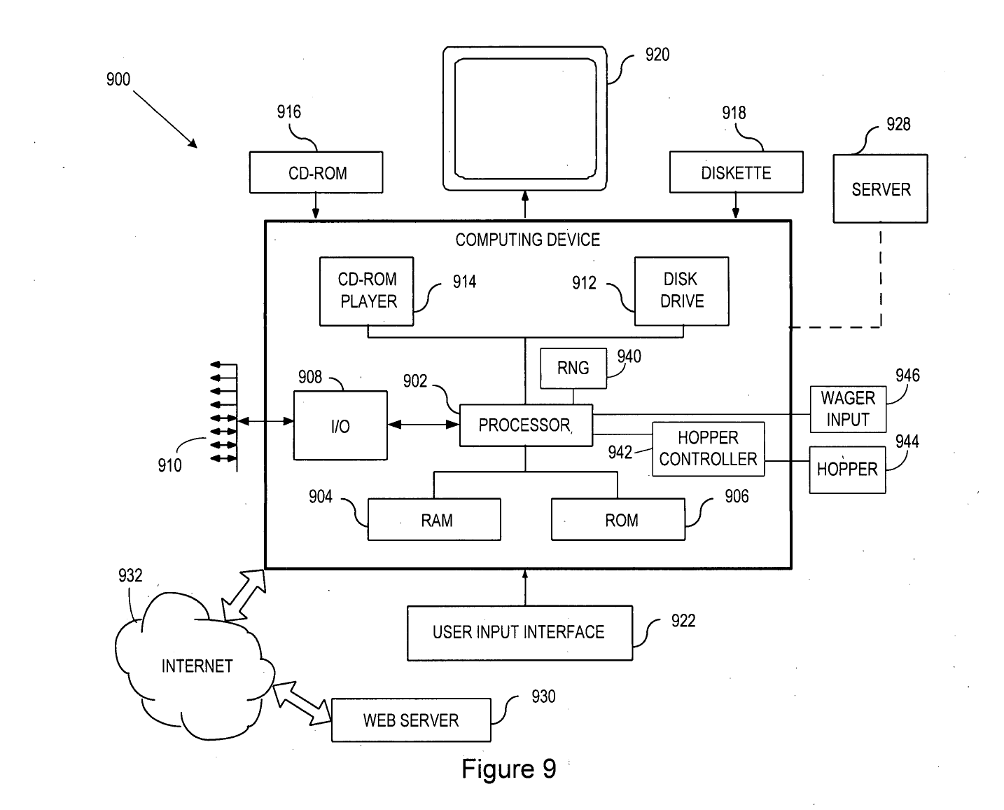

The gaming machines described in connection with the present invention may be independent casino gaming machines, such as slot machines or other special purpose gaming kiosks, video games, or may be computing systems operating under the direction of local gaming software and/or remotely-provided software such as provided by an application service provider (ASP). The casino gaming machines utilize computing systems to control and manage the gaming activity. An example of a representative computing system capable of carrying out operations in accordance with the invention is illustrated in FIG. 9.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 900 of FIG. 9 is an example computing structure that can be used in connection with such electronic gaming machines, computers, or other computer-implemented devices to carry out operations of the present invention.

The example computing arrangement 900 suitable for performing the gaming activity utilizing winning segments of corresponding adjacent element spanning at least two nodes in accordance with the present invention typically includes a central processor (CPU) 902 coupled to random access memory (RAM) 904 and some variation of read-only memory (ROM) 906. The ROM 906 may also be other types of storage media to store programs, such as programmable ROM (PROM), erasable PROM (EPROM), etc. The processor 902 may communicate with other internal and external components through input/output (I/O) circuitry 908 and bussing 910, to provide control signals, communication signals, and the like.

Chance-based gaming systems such as slot machines, in which the present invention is applicable, are governed by random numbers and processors. Electronic reels are used to display the result of the digital reels which are actually stored in computer memory and “spun” by a random number generator (RNG). RNGs are well-known in the art, and may be implemented using hardware, software operable in connection with the processor 902, or some combination of hardware and software. In accordance with generally known technology in the field of slot machines, the processor 902 associated with the slot machine, under appropriate program instruction, can simulate the vertical rotation of multiple reels. Generally, the RNG continuously cycles through numbers, even when the machine is not being played. The slot machine selects, for example, three random numbers. The numbers chosen at the moment the play is initiated are typically the numbers used to determine the final outcome, i.e., the outcome is settled the moment the reels are spun. The resulting random numbers are generally divided by a fixed number. This fixed number is often thirty-two, but for slot machines with large progressive Jackpots it may be even greater. After dividing, the remainders will be retained. For example, if the divisor was one-hundred twenty-eight, the machine would have three remainders ranging from zero to one-hundred twenty-seven. The remainders may be considered as stops on virtual reels. If the divisor was one-hundred twenty-eight, then the virtual reels would each have one-hundred twenty-eight stops with each stop being equally likely. Each stop on the virtual reel may be mapped to a stop on an actual reel or displayed reel image. These reel images may then be displayed on the display 920. The present invention is operable using any known RNG, and may be integrally programmed as part of the processor 902 operation, or alternatively may be a separate RNG controller 940. RNGs are well known in the art, and any type of RNG may be implemented for the standard mode of play and/or the bonus mode of play in accordance with the invention.

The computing arrangement 900 may also include one or more data storage devices, including hard and floppy disk drives 912, CD-ROM drives 914, and other hardware capable of reading and/or storing information such as DVD, etc. In one embodiment, software for carrying out the gaming operations in accordance with the present invention may be stored and distributed on a CD-ROM 916, diskette 918 or other form of media capable of portably storing information. These storage media may be inserted into, and read by, devices such as the CD-ROM drive 914, the disk drive 912, etc. The software may also be transmitted to the computing arrangement 900 via data signals, such as being downloaded electronically via a network, such as the Internet. Further, as previously described, the software for carrying out the functions associated with the present invention may alternatively be stored in internal memory/storage of the computing device 900, such as in the ROM 906. The computing arrangement 900 is coupled to the display 920, which represents a display on which the gaming activities in accordance with the invention are presented. The display 920 merely represents the “presentation” of the video information in accordance with the invention, and may be any type of known display or presentation screen, such as LCD displays, plasma display, cathode ray tubes (CRT), etc. Where the computing device 900 represents a stand-alone or networked computer, the display 920 may represent a standard computer terminal or display capable of displaying multiple windows, frames, etc. Where the computing device is embedded within an electronic gaming machine, such as slot machine 800 of FIG. 8, the display 920 corresponds to the display screen 810 of FIG. 8. A user input interface 922 such as a mouse or keyboard may be provided where the computing device 900 is associated with a standard computer. An embodiment of a user input interface 922 is illustrated in connection with an electronic gaming machine 800 of FIG. 8 as the various “buttons” 808. Other user input interface devices include a keyboard, a mouse, a microphone, a touch pad, a touch screen, voice-recognition system, etc.

In various embodiments of the invention, various aspects of the game, as described herein, may be player controlled. For example, a play may place bets, select game types, select play area types, select display grid types, select themes, select symbols, select colors, and/or select nodes.

The computing arrangement 900 may be connected to other computing devices or gaming machines, such as via a network. The computing arrangement 900 may be connected to a network server 928 in an intranet or local network configuration. The computer may further be part of a larger network configuration as in a global area network (GAN) such as the Internet. In such a case, the computer accesses one or more web servers 930 via the Internet 932.

Other components directed to slot machine implementations include manners of gaming participant payment, and gaming machine payout. For example, a slot machine including the computing arrangement 900 may also include a hopper controller 942 to determine the amount of payout to be provided to the participant. The hopper controller may be integrally implemented with the processor 902, or alternatively as a separate hopper controller 942. A hopper 944 may also be provided in slot machine embodiments, where the hopper serves as the mechanism holding the coins/tokens of the machine. The wager input module 946 represents any mechanism for accepting coins, tokens, coupons, bills, credit cards, smart cards, membership cards, etc. for which a participant inputs a wager amount.

Using the foregoing specification, the invention may be implemented as a machine, process, or article of manufacture by using standard programming and/or engineering techniques to produce programming software, firmware, hardware or any combination thereof.

Any resulting program(s), having computer-readable program code, may be embodied within one or more computer-usable media such as memory devices or transmitting devices, thereby making a computer program product or article of manufacture according to the invention. As such, the terms “article of manufacture” and “computer program product” as used herein are intended to encompass a computer program existent (permanently, temporarily, or transitorily) on any computer-usable medium such as on any memory device or in any transmitting device.

One skilled in the art of computer science from the description provided herein will be able to combine the software created as described with appropriate general purpose or special purpose computer hardware to create a computer system and/or computer subcomponents embodying the invention, and to create a computer system and/or computer subcomponents for carrying out methods of the invention.

The present invention disclosure contemplates the full breadth of subject matter included in the following descriptions.

Various embodiments of the invention for facilitating participation in a game can be carried out through, method steps comprising presenting a play area comprising a plurality of elements and at least two nodes; marking at least some of the elements; and dynamically identifying at least one winning segment of adjacently located elements with corresponding marks, the winning segment spanning the at least two nodes. Marking at least some of the elements may further comprise attributing a color to each marked element. Attributing the color to at least some elements may further comprise selecting the color for each marked element from a plurality of colors. Marking at least some of the elements may further comprise attributing a symbol to at least some elements. Attributing a symbol to each marked element may further comprise selecting the symbol for each marked element from a plurality of symbols. The markings of the winning segment of adjacently located corresponding elements may correspond to markings of the nodes between which the winning segment spans. At least one of the nodes from which the winning segment spans may be randomly selected from a plurality of nodes. The at least two nodes between which the winning segment spans may be randomly selected from a plurality of nodes. The nodes from which the winning segment spans may be marked and the node markings may correspond to the markings of the elements of the winning segment. The at least two nodes from which the winning segment spans may be on the periphery of the play area. The winning segment may span at least three nodes. The method may further include marking the at least two nodes, wherein the corresponding markings of the elements of the winning segment may also correspond to the markings of the at least two nodes. The winning segment of adjacently located elements may form a contiguous span between the two nodes. The method may be performed as a bonus as part of another game associated with the slot game. A payout may occur for each winning segment. The amount of each payout may be correlated to the number of marked elements of the winning segment. A wager may be lost if no winning segment is formed by the marked elements. Any two elements may be considered to be adjacently located if they share a common element wall or element corner. The markings of the winning segment may represent a sequential array of card types from a deck of cards.

Various embodiments of the invention for facilitating participation in a game can be carried out through method steps comprising, presenting a display grid and at least three nodes; populating the display grid with a plurality of marking elements, the marking for each element selected from a plurality of different markings; activating at least two of the at least three nodes; and identifying at least one winning segment, wherein the winning segment forms a contiguous segment of marking elements between, and in contact with, the at least two activated nodes, and all of the elements comprising the winning segment have corresponding markings. The at least two activated nodes may be randomly selected to be activated from the at least three nodes. The marking for each element is may be a color. The marking for each element may be a symbol. The method may further comprise marking the at least three nodes, wherein the corresponding markings of the elements of the winning segment also correspond to the markings of the at least two activated nodes. Populating the display grid with a plurality of marking elements may include randomly selecting the marking for each element. The at least two activated nodes may be located on opposites ends of the periphery of the play area.

Various embodiments of the invention for facilitating participation in a game can be carried out through method steps comprising presenting a play area that includes at least two nodes; marking the at least two nodes, the node markings selected from a plurality of different markings; populating the play area with a plurality of marking elements, the marking for each element selected from the plurality of different markings; and identifying at least one winning segment, wherein the winning segment forms a contiguous segment of marking elements between, and in contact with, the at least two nodes, and all of the elements comprising the winning segment, and the at least two nodes, have corresponding markings. The at least two nodes between which the winning segment forms a contiguous segment may be randomly selected from at least three nodes. The marking for each element may be randomly selected from a plurality of different colors. The marking for each element may be randomly selected from a plurality of different symbol. The method may further comprise issuing a payout for each winning segment according to a pay table. In some embodiments, each marking of the plurality of different markings can be repeatedly used in populating the play area and marking the nodes. Populating the play area may further comprise populating the play area with at least one null element that cannot correspond to any other element or node. Populating the play area may further comprise populating the play area with at least one wild element that can correspond to any other element or node.

Embodiments of the invention may include a gaming apparatus hosting a gaming activity, the gaming apparatus comprising a display device to present a display grid having a plurality of elements and at least two nodes; a random number generator configured to randomly select a marking for presentation for each of a plurality of elements of the display grid; and a processor configured to identify at least one winning segment of adjacently located elements with corresponding marks, the winning segment spanning the two nodes. The random number generator may be configured to select the marking for each of the plurality of elements from a plurality of different markings that can each be repeatedly selected for marking by the random number generator. The plurality of different markings may comprise a plurality of different color markings. The plurality of different markings may comprise a plurality of different symbol markings. The random number generator may be further configured to randomly select at least one of the nodes from the at least two nodes from which the winning segment spans. The gaming activity may be preformed as a bonus in conjunction with another gaming activity on the gaming apparatus. The random number generator may be further configured to randomly select a marking for presentation for each of the at least two nodes and the processor is further configured to identify the winning segment only if the corresponding marks of the winning segment also correspond to the marks of the nodes from which the winning segment spans. The processor may be further configured to recognize that any two elements are adjacently located if they share a common element wall segment or element corner.

Various embodiments of the present invention may include a computer-readable medium having computer-executable instructions for facilitating a gaming activity, the computer-executable instructions performing the steps comprising presenting a display grid comprising a plurality of display elements and at least two nodes; populating each display element with a color or symbol, the color or symbol randomly selected for each display element from a plurality of possible colors or symbols; and awarding a payout for each group of adjacently located elements with corresponding colors or symbols, the group forming a continuous segment between, and in contact with, the at least two nodes. Computer-executable instructions may further be provided for randomly selecting at least one of the at least two nodes from which the adjacently located corresponding elements span.

Various embodiments of the invention may include a slot machine comprising means for presenting a display grid comprising a plurality of elements and two nodes; means for presenting markings in a plurality of the elements and in the at least two nodes; and means for creating winning segments of adjacently located elements that are all correspondingly marked and span between the two nodes.

The foregoing description of the exemplary embodiment of the invention has been presented for the purposes of illustration and description. It is not intended to be exhaustive or to limit the invention to the precise form disclosed. Many modifications and variations are possible in light of the above teaching. For example, the present invention is not limited to what is traditionally known as “slot machines.” Also, while the illustrated embodiments have been described in large part in connection with a “slot machine,” other gaming systems and concepts are also within the scope of the invention, such as video poker games, card games, lotteries, and other casino events implementing a video screen. For example, a video poker game may utilize the present invention to provide multiple cards at each standard card display segment. It is thus intended that the scope of the invention be limited not with this detailed description, but rather by the claims appended hereto.

The following is claimed:

1. A method for facilitating participation in a game, comprising:
presenting a play area comprising a plurality of elements and at least two nodes;
marking at least some elements of the plurality of elements; and
dynamically identifying at least one winning segment of adjacently located elements with corresponding marks, the winning segment spanning the at least two nodes.

2. The method of claim 1, wherein the markings of the winning segment of adjacently located corresponding elements correspond to markings of the nodes between which the winning segment spans.

3. The method of claim 2, further comprising user selection of a marking type, wherein dynamically identifying the at least one winning segment of adjacently located elements with corresponding marks further comprises identifying the selected marking type in each element of the one at least one winning segment and the at least two nodes.

4. The method of claim 1, wherein the at least two nodes between which the winning segment spans are selected from a plurality of nodes by a user.

5. The method of claim 1, wherein the at least two nodes between which the winning segment spans are randomly selected from a plurality of nodes before the one winning segment is identified.

6. The method of claim 1, wherein the at least two nodes from which the winning segment spans are on the periphery of the play area.

7. The method of claim 1, further comprising marking the at least two nodes, wherein the corresponding markings of the elements of the winning segment also correspond to the markings of the at least two nodes.

8. The method of claim 1, wherein the winning segment of adjacently located elements forms a contiguous span between the two nodes.

9. The method of claim 1, further comprising issuing a payout, the amount of the payout correlated to the number of marked elements of the winning segment.

10. The method of claim 1, wherein marking the at least some of the elements further comprises randomly selecting each marking for each element from a plurality of different markings.

11. A method for facilitating participation in a game, comprising:
presenting a display grid and at least three nodes;
populating the display grid with a plurality of marking elements, the marking for each element selected from a plurality of different markings;
activating at least two of the at least three nodes; and
identifying at least one winning segment of elements with corresponding markings, the winning segment forming a contiguous segment of marking elements spanning the at least two activated nodes.

12. The method of claim 11, wherein the at least two activated nodes are randomly selected to be activated from the at least three nodes.

13. The method of claim 11, further comprising marking the at least three nodes, wherein the corresponding markings of the elements of the winning segment also correspond to the markings of the at least two activated nodes.

14. The method of claim 11, wherein populating the display grid with a plurality of marking elements includes randomly selecting the marking for each element from a plurality of different markings.

15. The method of claim 11, wherein the at least two activated nodes are located on opposites ends of the play area periphery.

16. A gaming apparatus hosting a gaming activity, the gaming apparatus comprising:
a display device configured to present a display grid having a plurality of elements and at least two nodes;
a random number generator configured to facilitate random selection of a marking for presentation for each of the plurality of elements of the display grid; and
a processor configured to facilitate identification of at least one winning segment of adjacently located elements with corresponding marks presented in the display grid, the winning segment spanning the two nodes.

17. The gaming apparatus of claim 16, wherein the processor is further configured to facilitate issuing a payout, the payout amount based on the number of elements of the winning segment.

18. The gaming apparatus of claim 16, wherein the random number generator is configured to facilitate selection of the marking for each of the plurality of elements from a plurality of different markings that can each be repeatedly selected for marking.

19. The gaming apparatus of claim 16, wherein the random number generator is further configured to facilitate random selection of at least one of the nodes from the at least two nodes between which the winning segment spans.

20. The gaming apparatus of claim 16, wherein the random number generator is further configured to facilitate random selection of a marking for presentation for each of the at least two nodes and the processor is further configured to facilitate identification of the winning segment only if the corresponding marks of the winning segment also correspond to the marks of the nodes between which the winning segment spans.

21. A computer-readable medium having computer-executable instructions for facilitating a gaming activity, the computer-executable instructions performing the steps comprising:
presenting a display grid comprising a plurality of display elements and at least two nodes;
populating each display element with a color or symbol, the color or symbol randomly selected for each display element from a plurality of colors or symbols; and
awarding a payout for each group of adjacently located elements with corresponding colors or symbols, the group forming a continuous segment spanning between the at least two nodes.

22. The computer-readable medium having computer-executable instructions for facilitating a gaming activity of claim 21, the computer-executable instructions performing the steps further comprising randomly selecting at least one of the at least two nodes from which the adjacently located corresponding elements span.

23. A slot machine comprising:
means for presenting a display grid comprising a plurality of elements and two nodes;
means for presenting markings in a plurality of the elements and in the at least two nodes; and
means for creating winning segments of adjacently located elements that are all correspondingly marked and span between the two nodes.

24. A method comprising:
presenting a group of elements;
presenting at least one of a plurality of different indicia with one or more of the elements of the group;
moving at least two nodes about an exterior of the group of elements, wherein the exterior includes a plurality of indicia that correspond to one or more of the indicia capable of being presented with the one or more elements of the group;
stopping the movement of the nodes, and identifying a node indicium on the exterior of the group of elements that is associated with the nodes when stopped;
identifying a winning payline between the at least two nodes if a chain of adjacent elements each present an indicium corresponding to the node indicium.

25. The method of claim 24, wherein:
the plurality of different indicia presented with the elements of the group comprise a plurality of different colors;
the plurality of indicia on the exterior of the group of elements comprises two or more of the plurality of different colors presented with the elements of the group;
identifying a node indicium on the exterior comprises identifying a color at the exterior of the group of elements that is associated the nodes when movement of the nodes is stopped; and
identifying a winning payline comprises determining if the chain of adjacent elements is formed with the same color that is associated with the nodes.
